(19) United States
(12) Patent Application Publication
(10) Pub. No.: US 2011/0050011 A1
(43) Pub. Date: Mar. 3, 2011

(54) Motor device

(75) Inventors: Dong Woo Rhee, Suwon (KR); Jun Kyu Park, Seoul (KR); Dong Yeon Shin, Suwon (KR)

(73) Assignee: SAMSUNG ELECTRO-MECHANICS CO., LTD., Suwon (KR)

(21) Appl. No.: 12/654,427

(22) Filed: Dec. 18, 2009

(30) Foreign Application Priority Data
Aug. 31, 2009 (KR) 10-2009-0081507

(51) Int. Cl. H02K 11/00

(52) U.S. Cl. 310/71

(57) ABSTRACT

A motor device includes a base plate on which a motor for rotating a disk is disposed, a flexible printed circuit board disposed on the base plate and having a circuit pattern applying power to the motor, and a screw mounting portion provided with a ground pattern of the FPCB, mounted with a screw engaged to electrically connect the ground pattern to the base plate, and having a part on which solders are provided.

### CROSS-REFERENCE TO RELATED APPLICATIONS

This application claims the priority of Korean Patent Application No. 10-2009-0081507 filed on Aug. 31, 2009, in the Korean Intellectual Property Office, the disclosure of which is incorporated herein by reference.

### BACKGROUND OF THE INVENTION

1. Field of the Invention

The present invention relates to a motor device, and more particularly, to a motor device in which a base plate is electrically connected with a ground pattern of a flexible printed circuit board on the base plate in a way that prevents damage to the flexible printed circuit board.

2. Description of the Related Art

In general, a spindle motor installed inside an optical disk drive serves to rotate a disk so that an optical pickup can read data stored in the disk.

Due to laptop computers or personal computers becoming slimmer and lighter, the optical disk drives used for such computers are also required to be slimmer and lighter.

Thus, market demands for slimmer spindle motors, main components of the optical disk drivers, are increasing.

In order to cope with such market demands, flexible printed circuit boards (FPCB) with a thickness ranging from 0.08 mm to 0.1 mm are increasingly being used instead of printed circuit boards (PCB) with a thickness ranging from 0.6 mm to 0.8 mm, which are typically used for the spindle motors.

A spindle motor is provided with a base plate to support a PCB or an FPCB. In general, a ground pattern of the PCB or the FPCB is electrically connected to the base plate through a screw in order to increase resistance to noise in the optical disk drive.

The FPCB, when grounded to the base plate using a screw, easily tears due to its low strength.

According to the related art, in order to prevent the FPCB from being torn, the screw coupling between the base plate and the FPCB is performed after providing solders to the entirety of a screw mounting portion of the ground pattern of the FPCB or inserting a washer into the screw mounting portion.

When the screw-coupling is performed after providing solders to the entirety of the screw mounting portion, the soldered solders are pushed out by the rotary force of a screw, tearing the FPCB.

The process of inserting the washer requires an additional material to be used, thereby increasing motor-material costs and increasing product manufacturing processes.

### SUMMARY OF THE INVENTION

An aspect of the present invention provides a motor device in which a base plate is electrically connected to a ground pattern of a flexible printed circuit board on the base plate in a way that prevents damage to the flexible printed circuit board.

According to an aspect of the present invention, there is provided a motor device including: a base plate on which a motor for rotating a disk is disposed; a flexible printed circuit board disposed on the base plate and having a circuit pattern applying power to the motor; and a screw mounting portion provided with a ground pattern of the FPCB, mounted with a screw engaged to electrically connect the ground pattern to the base plate, and having apart on which solders are provided.

The solders on the screw mounting portion may be provided in the form of a plurality of dots.

The solders on the screw mounting portion may be distributed in any half of the screw mounting portion.

The flexible printed circuit board may have a through hole through which the screw is passed, and the screw mounting portion may be provided around the through hole in a ring shape.

The screw mounting portion may have an outer circumference greater than that of a head of the screw.

According to another aspect of the present invention, there is provided a motor device including: a base plate on which a motor for rotating a disk is disposed; a flexible printed circuit board disposed on the base plate and having a circuit pattern applying power to the motor; a screw mounting portion provided with a ground pattern of the flexible printed circuit board; and a screw engaging the ground pattern of the flexible printed circuit with the base plate through the screw mounting portion, and including a screw head having a bottom surface contacting the screw mounting portion, the bottom surface partially provided with solders.

The solders on the screw may be provided in the form of a plurality of dots.

The solders on the screw may be distributed in any half of the bottom surface of the screw head.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a plan view illustrating a motor device according to an exemplary embodiment of the present invention;

FIG. 2 is a cross-sectional view illustrating the motor device of FIG. 1;

FIG. 3 is a cross-sectional view illustrating a first exemplary embodiment of grounding an FPCB to a base plate of the motor device of FIG. 1;

FIG. 4 is a plan view illustrating the FPCB of FIG. 3 partially provided with solders;

FIG. 5 is a cross-sectional view illustrating a second exemplary embodiment of grounding an FPCB to a base plate of the motor device of FIG. 1; and

FIG. 6 is a partially enlarged perspective view of a screw of FIG. 5 partially provided with solders.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, like reference numerals in the drawings denote like elements.

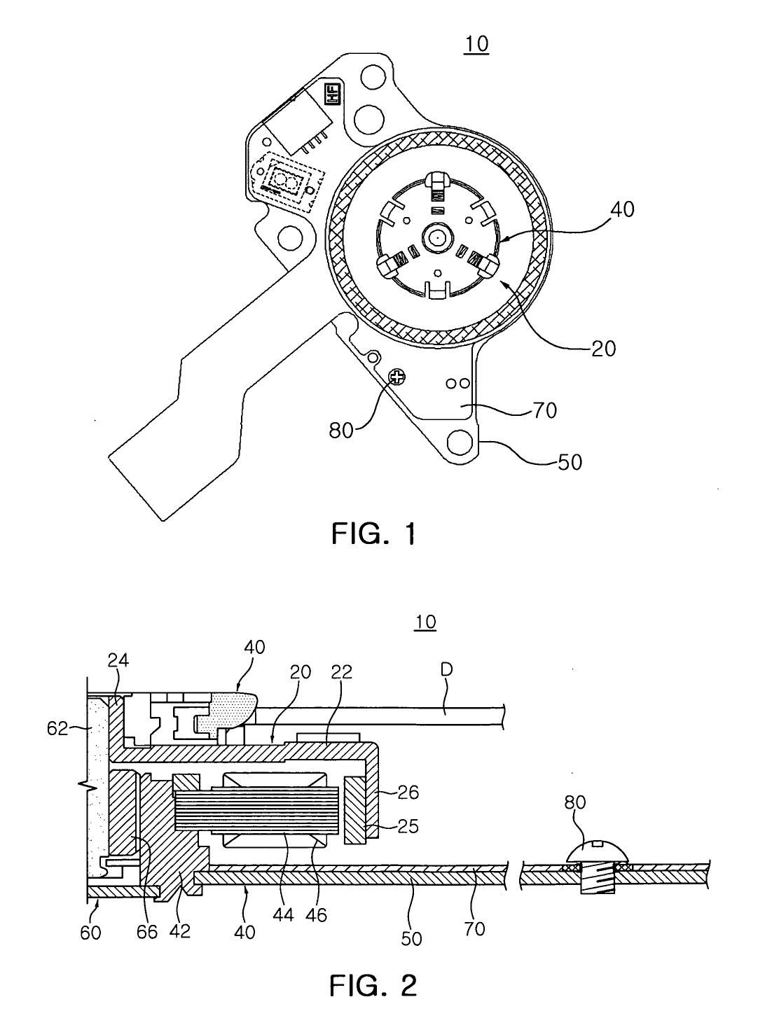

FIG. 1 is a plan view illustrating a motor device according to an exemplary embodiment of the present invention, and FIG. 2 is a cross-sectional view illustrating the motor device of FIG. 1.

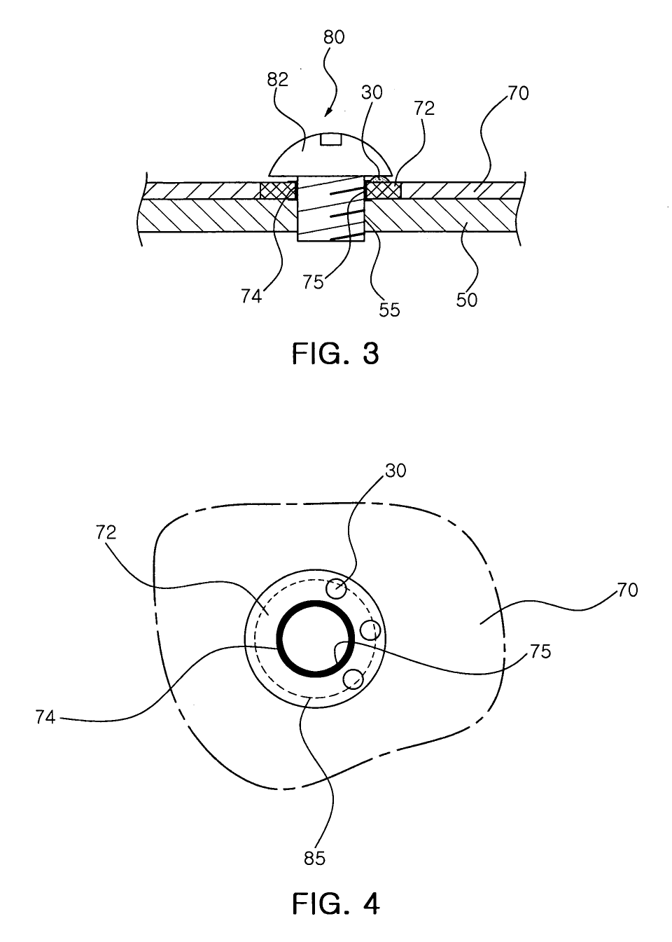

Referring to FIGS. 1 and 2, a motor device, according to an exemplary embodiment of the present invention, may include a base plate 50, a flexible printed circuit board (hereinafter, ‘FPCB’) 70, and a screw mounting portion (see reference number 72 FIG. 3).

A motor, according to this embodiment, may include a rotor 20, a stator 40 and a bearing assembly 60.

The rotor 20 includes a cup-shaped rotor case 22 provided with a magnet 25 having a ring shape and disposed on its inner circumferential portion corresponding to a coil 46 of the stator 40. The magnet 25 is a permanent magnet having N and S poles alternated in a circumferential direction to generate a magnetic force having a predetermined intensity.

The rotor case 22 includes a rotor hub 24 pressingly fitted on a shaft 62, and a magnet coupling portion 26 having an inner surface on which the annular magnet 25 is disposed. The rotor hub 24 is disposed around the upper portion of the shaft 62 in an axial direction in order to maintain an un-mating force with respect to the shaft 62. A chucking mechanism 40 for mounting a disk D is coupled to the outer circumferential surface of the rotor hub 24.

The stator 40 includes a support 42 supported outside a sleeve 66, a plurality of cores 44 fixed to the support 42, and a winding coil 46 surrounding the core 44.

The magnet 25 provided on the inner surface of the magnet coupling portion 26 faces the winding coil 46. The rotor 20 is rotated by electromagnetic interaction between the magnet 25 and the winding coil 46.

In addition, the bearing assembly 60 disposed inside the support 42 of the stator 40 includes the shaft 62 supporting the rotation of the rotor 20 and the sleeve 66 installed to render the shaft 62 rotatable.

As for terms regarding directions in the description, the axial direction refers to a vertical direction with respect to the shaft 62 in FIG. 1, and an outer diameter direction and an inner diameter direction refer to a direction toward the outer edge of the rotor from the shaft 62, and a direction toward the shaft 62 from the outer edge of the rotor 20, respectively.

The base plate 50 serves as a support on which the motor 10 is disposed. The FPCB 70 is provided on the base plate 50. The use of the FPCB 70 may achieve a reduction in the thickness of the motor device 10 as compared to the case of using a printed circuit board.

The FCPB may have a circuit pattern that supplies power to the motor.

A ground pattern (see reference number 74 in FIG. 3) of the FPCB 70 is electrically connected to the base plate 50.

Here, a screw 80 is used to couple and electrically connect the ground pattern of the FCPB 70 to the base plate 50.

Hereinafter, the construction for grounding the ground pattern of the FPCB 70 to the base plate 50 will now be described in more detail.

FIG. 3 is a cross-sectional view of a first exemplary embodiment of grounding the FPCB to the base plate of the motor device of FIG. 1. FIG. 4 is a plan view of the FPCB of FIG. 3 partially provided with solders.

Referring to FIGS. 3 and 4, solders 30 are provided on the screw mounting portion 72 in the form of a plurality of dots. The solders 30, provided in the form of dots, are spread to the entirety of the screw mounting portion 72 by the rotary force of the screw 80 rotated and engaged while passing through a through hole 55 of the base plate 50 and a through hole 75 of the FPCB 70 at a time.

The screw mounting portion 72 has a ring shape around the through hole 75 of the FPCB 70. The solders 30 having dot shapes may be distributed in any half of the screw mounting portion 72.

The outer circumference of the screw mounting portion 72 may be greater than that of a head 82 of the screw 80. This may prevent the solders 30 from flowing from the head 82 into a circuit pattern in the FPCB 70.

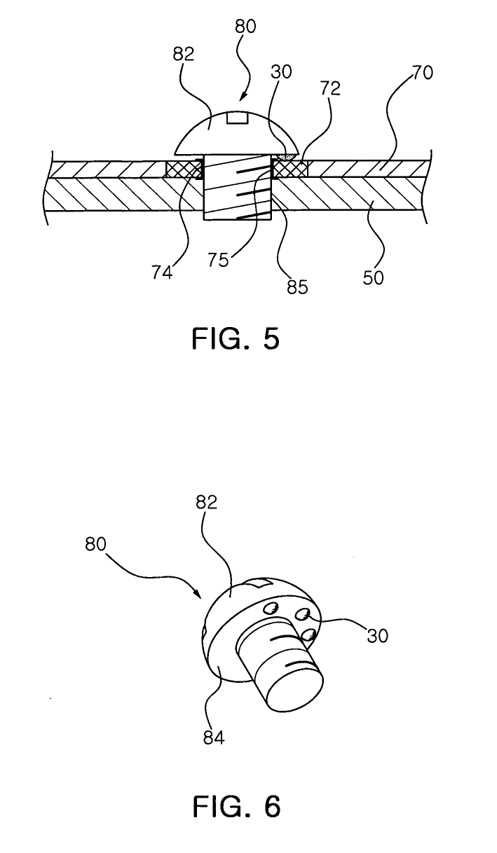

FIG. 5 is a cross-sectional view of a second exemplary embodiment of grounding the FPCB to the base plate of the motor device of FIG. 1, and FIG. 6 is a partially enlarged view of a screw of FIG. 5 partially provided with solders

Unlike the embodiment of FIGS. 3 and 4, the embodiment of FIGS. 5 and 6 forms solders 30 on a bottom surface 84 of the head 82 of the screw, rather than on the screw mounting portion 72 of the FPCB 70.

The solders 30 are provided in the form of dots on the bottom surface 84 of the head 82 of the screw 80, and may be distributed in any half of the bottom surface 84 of the head 82.

Other than the above construction, the embodiment of FIGS. 5 and 6 is identical to that of FIGS. 3 and 4.

As set forth above, according to exemplary embodiments of the invention, in the motor device, solders are provided in a part of the screw mounting portion of the FPCB or the bottom surface of the screw, rather than in the entirety of the screw mounting portion of the FPCB. Then, the rotary force of the screw causes the solders to be spread from the part of the screw mounting portion to the entirety of the screw mounting portion, without pushing out the solders outside the screw mounting portion, thereby preventing the FPCB from being damaged.

Also, since a washer, which is a separate member, is not used, the material costs can be reduced and the production process can be simplified.

While the present invention has been shown and described in connection with the exemplary embodiments, it will be apparent to those skilled in the art that modifications and variations can be made without departing from the spirit and scope of the invention as defined by the appended claims.

What is claimed is:

1. A motor device comprising:
a base plate on which a motor for rotating a disk is disposed;
a flexible printed circuit board disposed on the base plate and having a circuit pattern applying power to the motor; and
a screw mounting portion provided with a ground pattern of the FPCB, mounted with a screw engaged to electrically connect the ground pattern to the base plate, and having a part on which solders are provided.

2. The motor device of claim 1, wherein the solders on the screw mounting portion are provided in the form of a plurality of dots.

3. The motor device of claim 1, wherein the solders on the screw mounting portion are distributed in any half of the screw mounting portion.

4. The motor device of claim 1, wherein the flexible printed circuit board has a through hole through which the screw is passed, and
the screw mounting portion is provided around the through hole in a ring shape.

5. The motor device of claim 4, wherein the screw mounting portion has an outer circumference greater than that of a head of the screw.

6. A motor device comprising:
a base plate on which a motor for rotating a disk is disposed;
a flexible printed circuit board disposed on the base plate and having a circuit pattern applying power to the motor;
a screw mounting portion provided with a ground pattern of the flexible printed circuit board; and
a screw engaging the ground pattern of the flexible printed circuit with the base plate through the screw mounting portion, and including a screw head having a bottom surface contacting the screw mounting portion, the bottom surface partially provided with solders.

7. The motor device of claim 6, wherein the solders on the screw are provided in the form of a plurality of dots.

8. The motor device of claim 6, wherein the solders on the screw are distributed in any half of the bottom surface of the screw head.
